(19) United States
(12) Patent Application Publication
(10) Pub. No.: US 2002/0051441 A1
(43) Pub. Date: May 2, 2002

(54) Voltage offset compensating device of CDMA communication system transmitter

(75) Inventor: Dae-Hun Lee, Taegu (KR)

Correspondence Address: FLESHNER & KIM, LLP, P.O. Box 221200, Chantilly, VA, 20153-1200, US

(73) Assignee: Hynix Semiconductor, Inc.

(21) Appl. No.: 09/910,775

(22) Filed: Jul. 24, 2001

(30) Foreign Application Priority Data
Oct. 31, 2000 (KR) 64275/2000

(51) Int. Cl. H04B 7/216

(52) U.S. Cl. 370/342

(57) ABSTRACT

A voltage offset compensating device of a CDMA (Code Division Multiple Access) communication system transmitter is provided which is capable of compensating voltage offset by measuring real voltage of channels at a CDMA communication system transmitter and compensating for a voltage offset with a feedback loop. The voltage offset compensating device of the CDMA communication system transmitter includes a codec unit that converts a signal received from a microphone into a digital signal, a modem unit that converts the signal received from the codec unit into a digital signal adaptable to the CDMA method of communication by compensating voltage offset of the signal, and a BBA (Base Band Analog) unit that converts the digital signal received from the modem unit into an analog signal. The amount of voltage offset is detected by a voltage measuring unit which measures the voltage value of each channel of the BBA unit in accordance with a control signal of the modem unit, and creates a gidital signal in accordance with the voltage offset which is fed back to the modem unit to effect any necessary voltage offset compensation.

### BACKGROUND OF THE INVENTION

1. Field of the Invention

The invention relates to a CDMA (Code Division Multiple Access) communication system.

2. Background of the Related Art

FIG. 1 is a schematic block diagram illustrating a construction of a CDMA (Code Division Multiple Access) communication system transmitter. As depicted, the CDMA communication system transmitter of FIG. 1 comprises a codec unit 10 for converting a signal A inputted through a microphone 2 into a digital signal B. A modem unit 20 then converts the digital signal B applied from the codec unit 10 into a digital signal C adaptable to a CDMA method communication. The BBA (Base Band Analog) unit 30 converts the digital signal C into an analog signal D, and a RF unit 40 transmits the analog signal D applied from the BBA unit 30 with a frequency carrier signal designated by the CDMA method through an antenna 4 as signal E.

As depicted in FIG. 2, the BBA unit 30 includes DACs (Digital/Analog Converter) 31-1, 31-2 for converting separately an I channel digital signal and a Q channel digital signal, respectively, into analog signals, and filters 32-1, 32-2 for performing separately a low pass filtering of the analog signals received from the DACs 31-1, 31-2. The BBA unit 32 of FIG. 2 further includes mixers 33-1, 33-2 for mixing separately the filtered analog signals with a high frequency carrier signal, and an AGC (Automatic Gain Controller) 34 for automatically controlling the gain of the signals applied from the mixers 33-1, 33-2.

In a CDMA communication system transmitter such as that shown in FIG. 2, the signal A inputted through the microphone is converted into the digital signal B by the codec unit 10, the digital signal B is converted into the digital data C adaptable to CDMA method communication by the modem unit 20, and the digital data C is transmitted to the BBA unit 30. The BBA unit 30 performs a QPSK type processing. Accordingly, it comprises two channels (channel, Q channel) for the processing.

FIG. 2, signal F and signal G of the I channel have opposite phases, and signal H and signal I of the Q channel have opposite phases. Signal F and H are adjusted to be 90° out of phase with each other. When signal F and signal H are 90° out of phase, and when the modem unit 20 applies the digital signal to the DACs 31-1, 31-2 of the BBA unit 30, the modem unit 20 transmits the digital signal C to cause a 90° phase difference between the I channel and the Q channel. When the I channel and the Q channel are 90° out of phase, and when a center value within the input range of the DAC (for example, when the range of the DAC is 8 bits, because there are 256 values within the range from 00000000 to 11111111, the center value is determined as 01111111 or 01100000) is applied, the F and G signals have the same voltage, and the H and I signals have the same voltage.

The adjusted signals F, G, H, I are synthesized into high frequency signals by the mixers 33-1, 33-2. After mixing, the signals F, G, H, I are transmitted to the RF unit 40 after adjusting the gain through the AGC 34. The signals F, G, H, I are then transmitted with the frequency carrier signal designated by the CDMA method in conjunction with an output signal D from the BBA unit 30 through the antenna as signal E.

During the process, differences in the DC voltages of the I channel and the Q channel cause distortion of the transmitted signal. In addition to being susceptible to distortion caused by voltage differences, the design of the CDMA communication system transmitter of FIG. 2 requires a precise 90° phase difference between the F and H signals. A precise 90° phase difference is difficult to maintain in an operating system. As described above, when the voltages and phases of the two channels are distorted, it may cause the distortion of the transmitted signal which degrades communication quality.

### SUMMARY OF THE INVENTION

An object of the invention is to solve at least the above problems and/or disadvantages and to provide at least the advantages described hereinafter.

In order to solve at least the above-mentioned problems in whole, or in part, an object of the invention is to provide a voltage offset compensating device for a CDMA communication system transmitter which is capable of compensating voltage offset. A way of providing voltage offset compensation according to the invention is by measuring the voltages of two channels on the CDMA communication system transmitter and adjusting the DC offset with a feed back or compensation signal.

To achieve at least the above objects and advantages in a whole or in parts and in accordance with the purpose of the invention, as embodied and broadly described, a voltage offset compensating device for a CDMA (Code Division Multiple Access) communication system transmitter according to an embodiment of the invention is provided that includes a codec unit that converts a first analog signal inputted through a microphone into a first digital signal, a modem unit that converts the first digital signal inputted from the codec unit into a second digital signal adaptable to the CDMA method of communication by compensating voltage offset of the first digital signal, a BBA (Base Band Analog) unit that converts the second digital signal received from the modem unit into a second analog signal, and a voltage measuring unit that measures the voltage values of each channel of the BBA unit in accordance with a control signal of the modem unit, converts the measured voltage values into a third digital signal and feeds the third digital signal back into the modem unit as a compensation signal.

To further achieve at least the above objects and advantages in whole or in part and in accordance with the purpose of the invention, as embodied and broadly described, a method for voltage compensation of a CDMA (Code Division Multiple Access) system is provided that includes measuring at least one electrical signal of a plurality of electrical signals received by a BBA (Base Band Analog) unit from a modem unit, generating a compensation signal in proportion to the least one electrical signal, and adjusting the at least one electrical signal in proportion to the compensation signal.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic diagram illustrating a CDMA communication system transmitter;

FIG. 2 is a schematic diagram illustrating the BBA (Base Band Analog) unit of the CDMA communication system transmitter FIG. 1;

FIG. 3 is a schematic diagram illustrating a CDMA communication system transmitter according to an embodiment of the invention;

FIG. 4 is a schematic diagram illustrating the BBA unit and the voltage measuring unit of FIG. 3 according to the embodiment of the invention;

FIG. 5 is a schematic diagram of a voltage measuring unit according to another embodiment of the invention; and

FIG. 6 is a schematic diagram of a voltage measuring unit according to another embodiment of the invention.

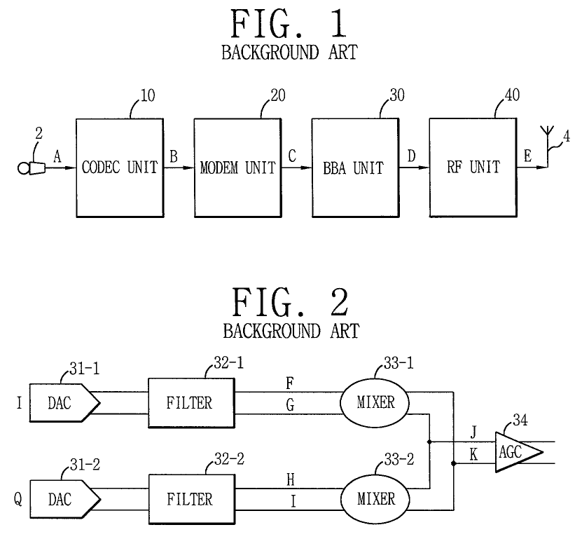

### DETAILED DESCRIPTION OF PREFERRED EMBODIMENTS

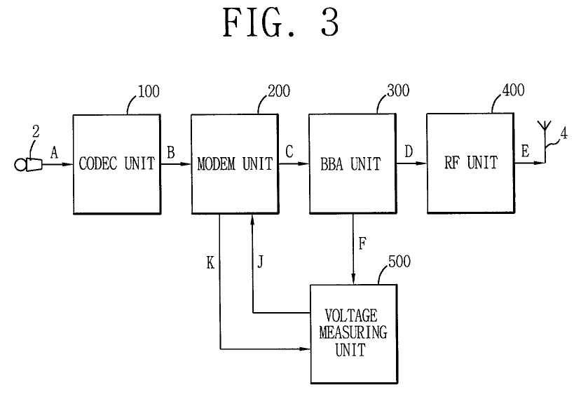

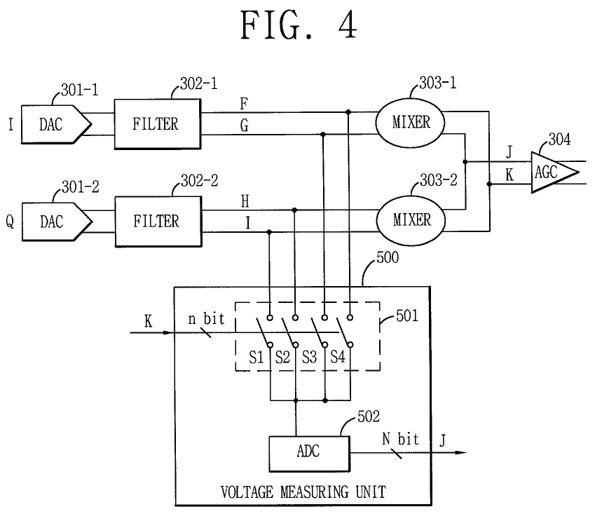

FIG. 3 is a schematic diagram illustrating a CDMA communication system transmitter according to an embodiment of the present invention. As depicted in FIG. 3, the CDMA communication system transmitter includes a codec unit 100 that converts a signal A received from a microphone 2 into a digital signal B. A modem unit 200 receives the digital signal B from the codec unit 100 and converts it into a digital signal C. Next, the digital signal C is adapted to the CDMA method of communication by compensating the voltage offset of the digital signal B. A BBA unit 300 then receives the digital signal C from the modem unit 200 and converts it into an analog signal D. An RF unit 400 receives the analog signal D from the BBA unit 300 and transmits the analog signal D with a frequency carrier signal designated by the CDMA method through an antenna 4 as signal E. A voltage measuring unit 500 measures the voltage value of each channel of the BBA unit 300 in accordance with a control signal K of the modem unit 200 and converts it into a digital signal J. The digital signal J is then fed back to the modem unit 200. When the modem unit 200 transmits the digital signal C to the BBA unit 300, the modem unit 200 transmits the voltage offset compensated signal to the BBA unit 300 after comparing it with the digital signal J received from the voltage measuring unit 500.

FIG. 4 schematically illustrates an embodiment of the BBA unit 300 and the voltage measuring unit 500 of FIG. 3 according to the invention. The BBA unit 300 may be constructed similarly to related art BBA units. The voltage measuring unit 500 may include a switching unit 501 which can select four signals F, G, H, I. The F and G signal may be used to form an I channel, and the H and I signals may be utilized to form a Q channel. According to this embodiment, the signals F, G, H, I are received from the filters 302-1, 302-2 of the BBA unit 300. The voltage measuring unit 500 may include switching unit 501 and an ADC (Analog to Digital Converter) 502. In the illustrated embodiment, the switching unit 501 includes four switches 51, 52, 53, 54. Based on the n-bit signal input K to the voltage measuring unit 500, the switching unit 501 selects one of the four signals F, G, H, or I, which in turn can be used as an input to the ADC 502. The ADC 502 then converts the selected signal value into a digital value which is received by the modem (not shown) as a feed back or compensation signal.

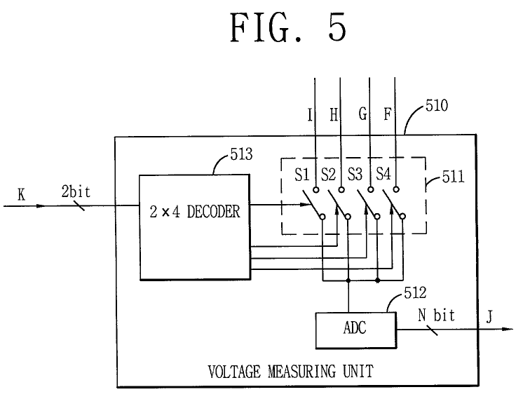

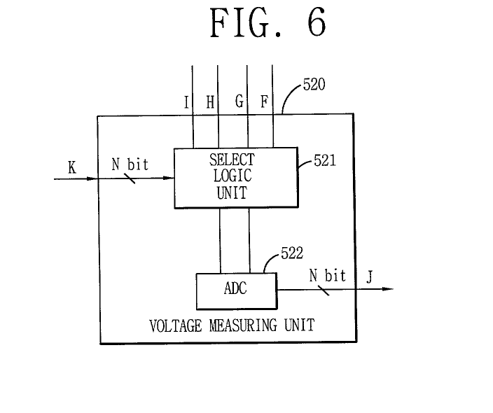

FIGS. 5 and 6 are schematic diagrams illustrating alternative embodiments of the voltage measuring unit 500, and will now be discussed. The voltage measuring unit 510 of FIG. 5 is configured to receive a 2-bit signal K received from the modem unit 200 by using a 2□4 decoder 513 to select a switch from among the switches 51, 52, 53, 54 of the switching unit 511. The voltage measuring unit 520 of FIG. 6 is configured to receive an n-bit signal K by using a select logic unit 521. The select logic unit 521 is configured to select two signals among the signals F, H, G, I as inputs of the differential ADC 522. The differential ADC 522 then receives the inputs and converts the analog value of the difference between the two inputs into the digital value as the output J of the voltage measuring unit 520.

Referring to FIG. 3, the signal A received from the microphone 2 is converted into a digital signal B by the codec unit 100. Digital signal B is converted into a digital data signal C adaptable to the CDMA method of communication by the modem unit 200 while digital data signal C is received by the BBA unit 300. The BBA unit 300 performs a QPSK type processing on the divided two channels, I and Q. The signals F, G, H, I preferably have a predetermined voltage value when the modem unit 200 applies the digital data signal C to the DACs 301-1, 301-2 (shown in FIG. 4) of the BBA unit 300 and when a certain digital code value is inputted to the DACs of the two channels. However, because the voltage value can be changed in accordance with each of the signals F, G, H, I, the modem unit 200 can apply a certain bit (for example, 2 or 4 bit) control signal K to the voltage measuring unit 500.

Based on the value of the control signal K, a single switch from among the switches S1, S2, S3, S4 inside of the switching unit 501 of the voltage measuring unit 500 is closed. By closing the appropriate switch based on the control signal K, the voltage value of the pertinent signal among the signals F, G, H, I of the two channels can then be inputted to the ADC 502.

The ADC 502 converts the voltage value of the pertinent channel inputted through the analog-digital conversion into the n-bit digital signal J, and feeds it back to the modem unit 200. Based on the value of the digital signal J, the modem unit 200 compares the voltage value of the certain channel signal inputted from the voltage measuring unit 500 with the voltage value of the ideal case, and stores the difference value. The modem unit 200 then uses the stored difference value to compensate the signal before transmitting it to the BBA unit 300. Accordingly, the normal signal transmission process can be performed without the signal distortion by compensating the voltage value using the present input signal.

A plurality of methods for selecting and measuring the voltage about the signals F, G, H, I on the voltage measuring unit 500 can be used. The embodiments of the voltage measuring unit shown herein are intended for illustrative purposes and should not be construed as limitations of the present invention.

As discussed above and as depicted in FIG. 5, the voltage measuring unit 510 according to one embodiment of the invention includes the 2×4 decoder 513. The voltage measuring unit 510 receives a 2-bit control signal K from the modem unit 200. Then, based on the control signal K, the voltage measuring unit 510 selects one of the signals F, G, H, I, and measures the selected signals. As depicted in FIG. 6, voltage measuring unit 520 according to another embodiment of the invention receives a n-bit control signal K and based on the control signal K, two signals are selected from among the signals F, G, H, I for input to the ADC 522 as a differential input. The ADC 522 then converts the difference value of the two signals of the differential input into a digital value and transmits the digital value to the modem unit as a feed back or compensation signal.

Therefore the preferred embodiments of the invention prevent signal distortion due to the voltage offset by measuring directly the voltage offset of each channel generated in the CDMA communication system using the QPSK method, compensating it, and outputting it.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A voltage offset compensating device for a Code Division Multiple Access (CDMA) communication system transmitter, comprising:
a codec unit that converts a first signal inputted through a microphone into a digital second signal;
a modem unit that converts the first signal inputted from the codec unit into a digital third signal adaptable to a CDMA method communication by compensating a voltage offset of the second signal;
a Base Band Analog (BBA) unit that converts the digital third signal applied from the modem unit into an analog fourth signal; and
a voltage measuring unit that measures a voltage value of a plurality of channels of the BBA unit in accordance with a control signal of the modem unit, converts it into a digital fifth signal, and feeds the digital fifth signal into the modem unit.

2. The device of claim 1, wherein the modem unit compensates the voltage offset of the digital second signal inputted from the codec unit in accordance with a signal inputted from the voltage measuring unit, and outputs the digital third signal.

3. The device of claim 1, wherein the voltage measuring unit comprises: a switching unit that selects a signal from among signals of the plurality channels of the BBA unit in accordance with the control signal of the modem unit and outputs said selected signal; and
an ADC (Analog to Digital Converter) that converts the voltage value from the switching unit into the fifth digital signal and transmits the control signal to the modem unit.

4. The device of claim 3, wherein the voltage measuring unit further comprises a decoder that outputs a sixth signal that controls the switching unit by combining the control signal from the modem unit.

5. The device of claim 1, wherein the voltage measuring unit comprises:
a switching unit that selects two signals from among signals of two channels of the BBA unit in accordance with the control signal of the modem unit and outputs said selected two signals; and
an ADC that converts the differential value of the two signals applied from the switching unit into a digital seventh signal and transmits said digital seventh signal to the modem unit.

6. A voltage compensating CDMA (Code Division Multiple Access) system, comprising:
a modem unit;
a BBA (Base Band Analog) unit electrically coupled to the modem unit; and
a voltage measuring unit electrically coupled to said BBA unit and said modem unit, wherein said voltage measuring unit receives at least one electrical signal, said voltage measuring unit generates a compensation signal in accordance with said at least one electrical signal, and said modem unit receives said compensation signal and adjusts said at least one electrical signal in accordance with said compensation signal.

7. The system of claim 6, wherein a D.C. voltage offset of said at least one electrical signal is adjusted in proportion to said compensation signal.

8. The system of claim 6, further comprising:
a control signal received by said voltage measuring unit, wherein said control signal determines which of said at least one electrical signal causes said voltage measuring unit to generate said compensation signal.

9. The system of claim 8, wherein said control signal is generated by said modem unit.

10. The system of claim 8, wherein said voltage measuring unit comprises an ADC.

11. The system of claim 10, wherein said voltage measuring unit comprises:
a switching unit that receives said control signal which causes said ADC to be electrically connected to at least one of said plurality of electrical signals and said ADC generates said compensation signal.

12. The system of claim 11, wherein said control signal comprises a digital signal, said switching unit comprises four switches, and said plurality of electrical signals comprises four voltage signals.

13. The system of claim 11, wherein said voltage measuring unit comprises a 2×4 digital decoder and a switching unit, and said 2×4 digital decoder receives said control signal and generates a switching signal, and said switching unit receives said switching signals which causes said ADC to be electrically connected to at least one of said plurality of electrical signals, and said ADC generates said compensation signal.

14. The system of claim 11, wherein said control signal comprises a 2-bit digital signal, said switching unit comprises four switches, and said plurality of electrical signals comprises four voltage signals.

15. The system of claim 8, wherein said voltage measuring unit comprises:
a select logic unit electrically connected to said BBA unit; and
a differential input ADC electrically connected to said select logic unit, wherein said select logic unit receives said control signal which causes said differential input ADC to be electrically connected to at least two of said plurality of electrical signals, and said differential input ADC generates said compensation signal.

16. The system of claim 6, further comprising a codec unit electrically coupled to said modem unit.

17. The system of claim 6, further comprising an RF (Radio Frequency) unit electrically coupled to said BBA unit.

18. A method for voltage compensation of a CDMA (Code Division Multiple Access) system, comprising:
measuring at least one electrical signal of a plurality of electrical signals received by a BBA (Base Band Analog) from a modem unit;
generating a compensation signal according to the measurement of said least one electrical signal; and
adjusting said at least one electrical signal in accordance with said compensation signal.

19. The method of claim 18, wherein the adjusting step further comprise:
adjusting a D.C. voltage offset of said at least one electrical signal in accordance with said compensation signal.

20. The method of claim 18, further comprising:
generating a control signal; and
selecting said at least one electrical signal from said plurality of electrical signals in accordance with said control signal.

21. An apparatus for voltage compensation of a CDMA system, comprising:
means for measuring at least one electrical signal of a plurality of electrical signals received by a BBA (Base Band Analog) from a modem unit;
means for generating a compensation signal according to the measurement of said least one electrical signal; and
means for adjusting a D.C. voltage offset of said at least one electrical signal in accordance with said compensation signal.
